(19) United States
(12) Patent Application Publication
(10) Pub. No.: US 2016/0325834 A1
(43) Pub. Date: Nov. 10, 2016

(54) IN-FLIGHT BATTERY RECHARGING SYSTEM FOR AN UNMANNED AERIAL VEHICLE

(71) Applicant: Curtis Asa Foster, Atlanta, GA (US)

(72) Inventor: Curtis Asa Foster, Atlanta, GA (US)

(21) Appl. No.: 15/149,972

(22) Filed: May 9, 2016

Related U.S. Application Data
(60) Provisional application No. 62/158,309, filed on May 7, 2015.

(51) Int. Cl. B64C 39/02; B64D 27/24; B64C 27/14

(52) U.S. Cl. CPC B64C 39/024; B64C 27/14; B64D 27/24; B64C 2201/066; B64C 2201/042; B64C 2201/108; B64C 2201/162; B64C 2201/024

(57) ABSTRACT

An in-flight battery recharging system for Unmanned Aerial Vehicle (UAV). This invention converts byproducts of a multi-rotor unmanned aerial vehicle's conventional propulsion system operation and airframe movements to generate electricity that, in turn, is used to power the propulsion system's electric motors, power onboard electronic components, and recharge the battery that initially powers the propulsion system's electric motors. Having this ability of recharging the battery in-flight gives an unmanned aerial vehicle a much improved flight time and range, thereby greatly increasing its utility.

### CROSS-REFERENCE TO RELATED APPLICATION

This application claims the benefit of priority of U.S. provisional application No. 62/158,309, filed May 7, 2015, the contents of which are herein incorporated by reference.

### BACKGROUND OF THE INVENTION

The present invention relates small unmanned aerial vehicles, and more particularly to apparatus for extending the flight times of such vehicles. The vast majority of small unmanned aerial vehicles have very short maximum flight times due to limitations of commercially-available batteries. These flight times typically range between 8 and 45 minutes, afterwards requiring landing and recharging for an hour or more before flying again.

Existing unmanned aerial vehicles, particularly of the multi-rotor variety, such as quadcopters, hexacopters, and octocopters, expend large amounts of energy to achieve vertical flight. Payload capabilities of these aircraft are typically very limited, and that limitation contributes to the minimal power source that the vehicle can lift. A vehicle with a high energy burn-rate and a very limited power source will have a limited flight time before its power source will have to be recharged.

Multi-rotor unmanned aerial vehicles (multi-rotors) used for recreational purposes do not draw much attention to the downsides inherent of limited flight times. Hobbyists fly the vehicles in a very limited geographic area. However, when multi-rotors are used for practical purposes, such as surveying miles of pipelines, power lines, crops, or shoreline, or perhaps providing aerial security to a far-traveling motorcade, the limitation of a short flight range becomes of paramount importance. This is the reason existing multi-rotors find it difficult to effectively serve in practical roles.

As can be seen, there is a need to converts byproducts of a multi-rotor's conventional propulsion system operation and airframe movements to generate electricity that, in return, is used to power the propulsion system's electric motors, power onboard electronic components, and recharge the battery that initially provides power that equipment. Having this ability of recharging the battery in-flight gives an unmanned aerial vehicle a much improved flight time and range, thereby greatly increasing its utility.

### SUMMARY OF THE INVENTION

In one aspect of the present invention, 1. An in-flight charging system for an unmanned aerial vehicle (UAV), includes: a hub portion, a motor attached to the hub portion via a support arm, a rotor rotationally driven by the motor to produce a thrust airflow; and a prop oriented for rotational movement in the thrust airflow and operatively coupled to a generator via a generator shaft, the generator producing a first electrical charge responsive to the rotational movement of the prop with the thrust airflow. The charging system may further include a power conditioning circuit, coupled to the generator, and configured to produce a regulated direct current output from the first electrical charge. In some embodiments, a battery, is operatively coupled to the power conditioning circuit, wherein an output of the power conditioning circuit charges the battery. Preferably, the prop is coaxially aligned with the rotor.

In other aspects of the invention, the power conditioning circuit includes an AC to DC rectifier coupled to the generator; a voltage regulator coupled to the AC to DC rectifier; a boost converter; and a battery charger integrated circuit. In alternative embodiments, the in-flight charging system may also include a storage capacitor operatively coupled to the voltage regulator.

In yet other aspects of the invention a micro generator may be operatively coupled to a motor shaft, and the micro generator is adapted to produce a second electrical charge with rotation of the motor shaft. The power conditioner may be configured receives this second electrical charge.

In an additional aspect of the invention, the in-flight charging system may also include an auxiliary generator that is operatively coupled to the hub portion. The auxiliary generator may be driven by an auxiliary prop oriented to receive an airflow across the hub.

In yet another embodiment of the invention, the motor is a ducted fan and a flight control surface oriented subjacent to an outlet of the ducted fan.

These and other features, aspects and advantages of the present invention will become better understood with reference to the following drawings, description and claims.

### BRIEF DESCRIPTION OF THE DRAWINGS

FIG. 1 is a perspective view of the invention shown in use with an unmanned aerial vehicle.

FIG. 2 is a side view of the invention shown in use with an unmanned aerial vehicle.

FIG. 3 is a perspective view of an alternate embodiment of the invention shown in use.

FIG. 4 is a side detail view of an alternate embodiment of the invention shown in use.

FIG. 5 is a top perspective view of an alternate embodiment of the invention.

FIG. 6 is a bottom perspective view of an alternate embodiment of the invention.

FIG. 7 depicts an embodiment of an electrical diagram according to aspects of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an electrical power generation system that scavenges a portion of the thrust developed in an unmanned aerial vehicle to recharge an electrical storage system, such as a battery.

As stated above, the vast majority of small unmanned aerial vehicles (UAV) have very short maximum flight times due to limitations of commercially-available batteries. These flight times typically range between 8 and 45 minutes, afterwards requiring landing and recharging for an hour or more before flying again.

Existing unmanned aerial vehicles, particularly of the multi-rotor variety such as quadcopters, hexacopters, and octocopters, expend large amounts of energy to achieve vertical flight. Payload capabilities of these aircraft are very limited, and that limitation contributes to the minimal power source that the vehicle can lift. A vehicle with a high energy burn-rate and a very limited power source will have a limited flight time before its power source will have to be recharged. Certain components of the UAV, such as landing gear, radio controlled operation via transmitters and receivers, are well understood in the art. While they may be components of the UAV contemplated herein, they are not necessary for an understanding of the invention.

Aspects of the present invention converts byproducts of an unmanned aerial vehicle's propulsion system operation and airframe movements into electricity that, in return, is used to power the propulsion system along with other onboard electrical systems, as well as recharge the battery initially powering that equipment. Having this ability of recharging the battery in-flight gives an unmanned aerial vehicle a much improved flight time and range, thereby greatly increasing its utility.

The present invention is an improvement over other component configurations used on existing multi-rotor unmanned aerial vehicles due to the increase in flight time and operational range it provides vehicles utilizing the invention. This increased range greatly increases the utility of multi-rotor UAVs by allowing missions of much longer duration over areas much further away from the vehicle's point of origin.

The electric motors used by existing multi-rotor UAVs consume relatively large amounts of electric power in order to achieve lift. The batteries used (typically lithium-ion polymer) usually represent a substantial size and weight in comparison to the vehicle carrying it, and they are only able to power the electric motors of the vehicle for a period of time that is too short for many commercial applications that require flight times of an hour or more.

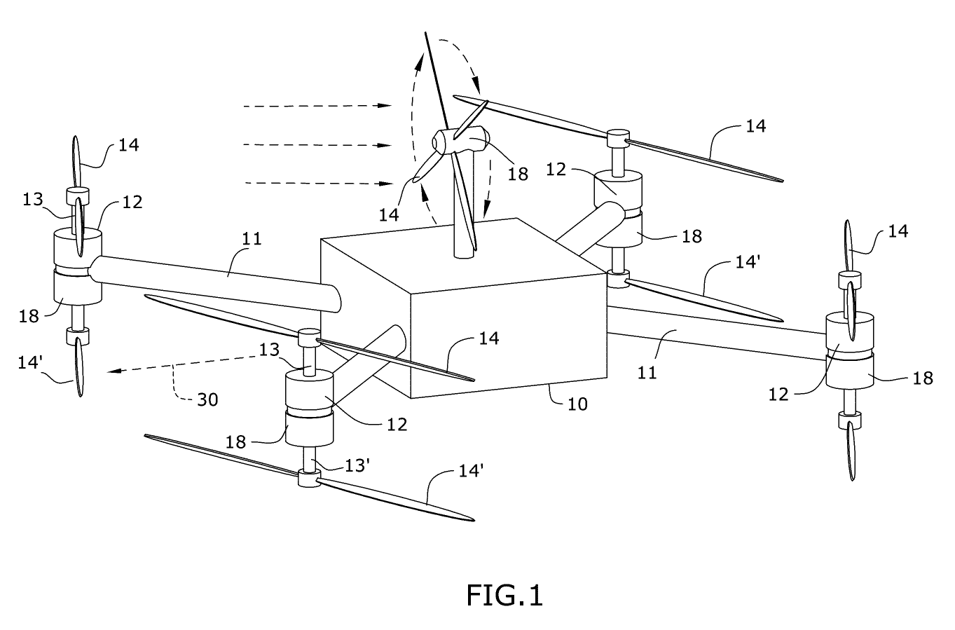

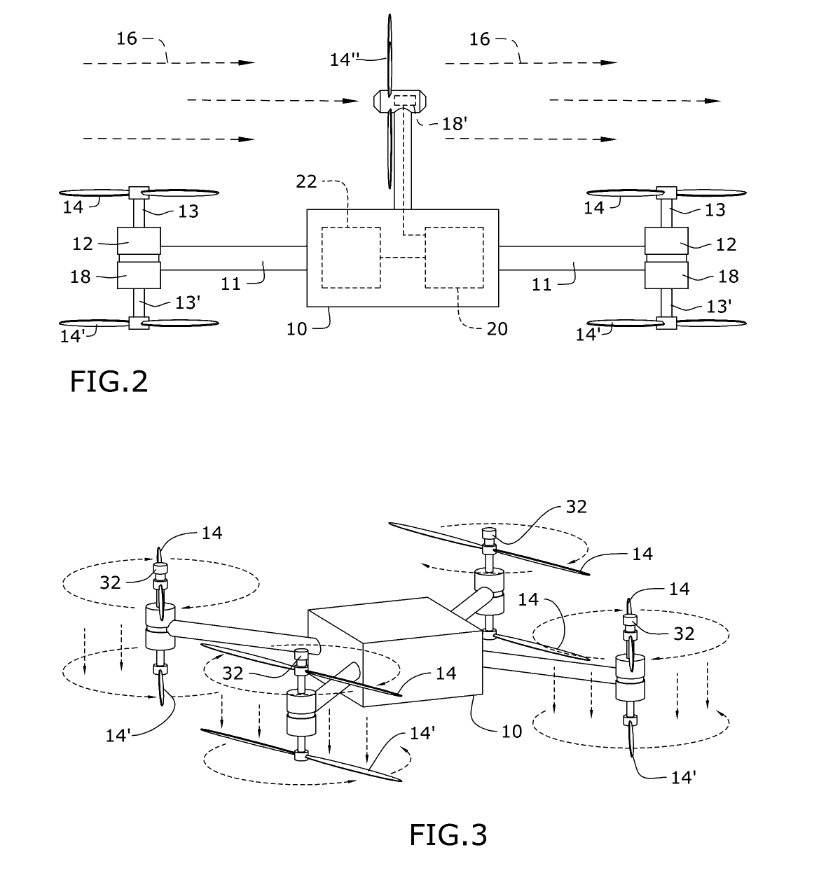

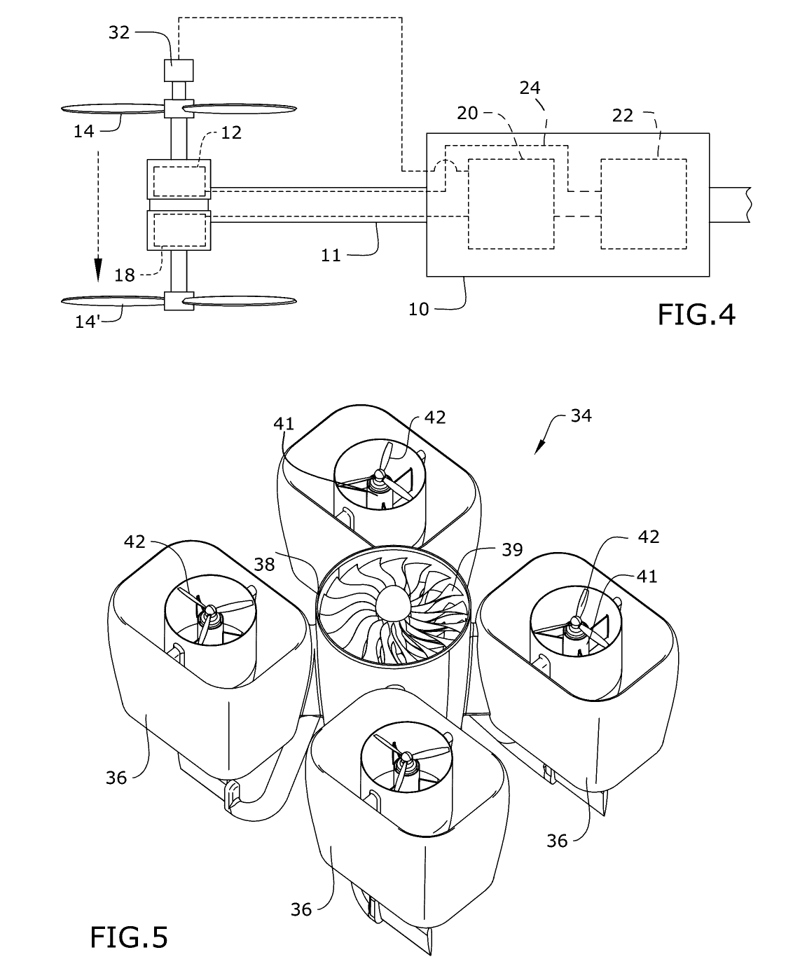

As seen in reference to FIGS. 1-4, an embodiment of an unmanned aerial vehicle is depicted. The UAV has a body hub 10, and a plurality of motors 12 disposed about the body and connected via a support arm 11. One or more powered electric motors 12 rotate a rotor or fan 14, with the rotor 14 either attached directly to a rotating shaft 13 of the electric motors 12 or to a gearbox attached to the shafts of the electric motors 12.

One or more rotors/fans 14 may be attached to each electric motor 12 or gearbox (not shown), depending on the thrust generation requirements of each motor 12 and the overall lift and flight performance requirements of the multi-rotor. The number of electric motor 12 and propeller/fan 14 assemblies used on the multi-rotor may vary depending on the lift and flight performance requirements of the vehicle.

Adjacent or otherwise in close proximity to the powered electric motor 12 is one or more electric generators 18. These electric generators 18 each have one or more prop/fans 14′ either attached to its rotating shaft or to a gearbox attached to said shaft. The electric generator 18 and prop 14′ assemblies are oriented in such a way that at least a portion of the thrust from the powered electric motor 12 and rotor/fan 14 assemblies blow directly onto, and cause rotation of the props 14′ attached to the electric generators 18 either directly via a shaft 13′ or by way of the gearbox.

Micro generators 32 are smaller versions of electric generators 18. Micro generators 32 are attached to either the shafts 13 of the electric motors 12, the center hubs of the propellers/fans 14 that are mounted on said shafts 13, or gearboxes that are attached to either the shafts 13 of the electric motors 12 or the center hubs of the propellers/fans 14, so that each rotation of the shaft 13 of an electric motor 12 results in one or more rotations of the shaft of the attached micro generator 32.

An auxiliary electric generator 18′ and associated prop assemblies 14″, or Electric generator 18′ gearboxes propeller/fan 14″ assemblies, or a combination of both, can be affixed to various locations on the multi-rotor UAV in such a fashion to interact with ambient and dynamic wind currents around the vehicle for the purpose of rotating propeller/fan 14″ assemblies, attached gearboxes (when utilized), and electric generator 18′ shafts, for the purpose of generating additional electric power.

Electric wiring 24 connects the rechargeable battery 22 to an Electronic Speed Controller (ESC) 50 which controls the power delivered to motors 12 and provides stabilization and maneuverability for the UAV. Electric wiring 24 connects each electric generator 18 and micro generator 32 to the AC-to-DC rectifier 20. Electric wiring 24 connects the AC-to-DC rectifier 20 to the Step-up (boost) converter 23. An optional capacitor 26 may connect between the rectifier 21 and the voltage regulator 27. The voltage regulator 27, is in turn operatively connected to the Battery charger 22. Electric wiring 24 connects the battery charger 22 to the rechargeable battery 22.

The rechargeable battery 20 provides electricity through the ESC's 50 to the electric motors 12 and propellers 14 of the propulsion system. The activation of this electric motor 12 rotates the propeller 14 (either connected directly to the shaft 13 of the motor or to a gearbox which is connected to the shaft of the motor), which generates thrust and propulsion for the multi-rotor unmanned aerial vehicle. As will be familiar to those in the art, the process described thus far is how most existing multi-rotor UAVs operate.

According to aspects of the present invention, the electric generator 18 and the attached propellers/fans 14′, which may be attached either directly to the generator shaft 13′ (or to gearboxes attached to the generators' shaft) is positioned within the rotor wash (thrust airflow) generated by the electric motors 12 and rotor 14. The rotor wash rotates the prop 14′, attached to the electric generator's shaft 13′ which generates an electric charge.

As seen in reference to FIG. 3, micro generators 32 can also be used to generate additional power for use by the system. These micro generators 32 can be attached to the shafts 13 of the electric motors 12 and/or larger electric generators, either by connecting shaft of the micro generator 32 to shaft 13 of motor 12 or the generator 18, or by connecting shaft of the micro generator 32 to a gearbox which is attached to the shaft 13 of the motor 12 or other generator 18′.

As the laws of physics prevents the power from the generators 18, 18′, and/or micro generators 32 in the system described thus far to generate sufficient power to recharge the battery 20 or power the motors 12 that generate the forces necessary to turn the generators 18 and or micro generators 32, additional power from outside this system will be required to accomplish this. Additional generators 18′ and propellers/fans 14 can be placed on the frame 10 of the multi-rotor in such a fashion so as to harness airflow around the vehicle as it moves and use the airflow to turn generators 18.

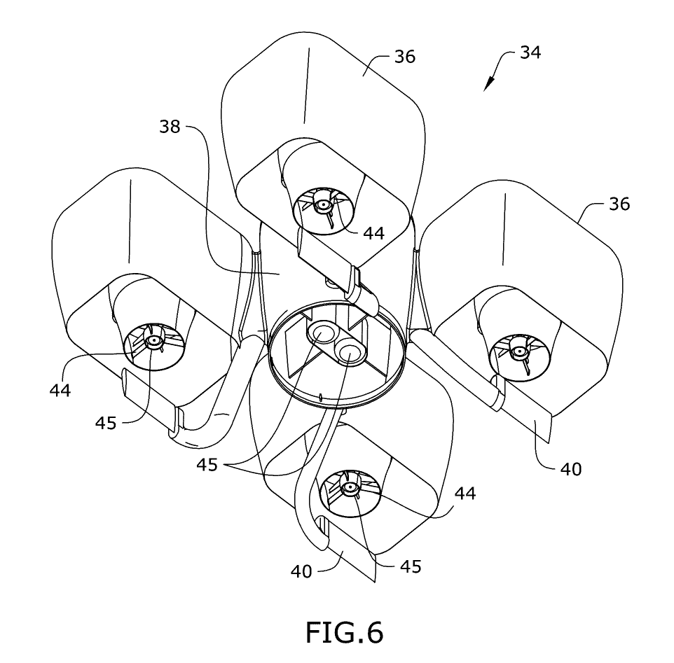

In an alternative embodiment of a drone 34 seen in reference to FIGS. 5 and 6, the drone 34 may comprises a plurality of drone wing surfaces 36 disposed about a central body portion 38. The drone wing surfaces 36 substantially surround a motor 41 for driving a propeller 42 to provide the thrust necessary for maneuvering the drone 34. The motor 41 and propeller 42 are formed in a ducted fan configuration. In this embodiment, the central body portion 38 may also include a central turbine 39, for providing additional electrical power for the vehicle 34. A generator 45 is coupled at an outlet of the motor 41, and a generator propeller 44 harnesses a portion of the output thrust for generating electrical power for the drone 34. A flight control surface 40 is disposed subjacent to the outlets of the motor 41. The flight control surface 40 is configured as an airfoil that direct the outlet thrust and provide directional control for the drone 34. In operation the drone 34 may operate in a hovering mode, such as shown in FIG. 5 and may rotate about the central body portion 38 roughly 90 degrees to enter into a forward flight mode. Accordingly, the turbine 39 may rotate to generate electrical power from the airflow encountered during the forward flight mode.

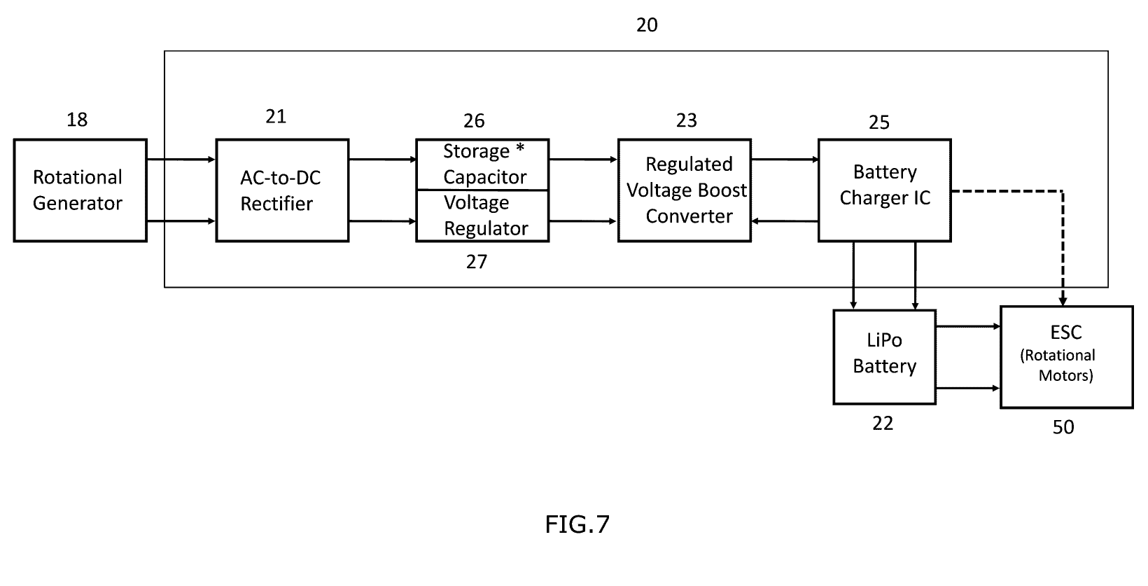

As seen in reference to FIG. 7, generated electricity from generators 18 and micro generators 32 is channeled via connected electrical wires 24 to the power conditioning components 20. The power conditioning components 20 may include an AC-to-DC rectifier 21 which converts the power from alternating current (AC) to direct current (DC). The AC-to-DC rectifier 21 is connected by electrical wiring 24 to a step-up regulated voltage boost converter 23, which increases the generator 18 output power to the required voltage level in order to charge the battery 20. The step-up boost converter 23 may also be connected by electrical wiring 24 to a storage capacitor 25. The storage capacitor 25, is used to store the energy and to reduce the output voltage from the boost converter 23. The storage capacitor 25 is connected by electrical wiring 24 to a voltage regulator 27 which supplies a constant (steady) voltage to a load, which may be the rechargeable battery 20 and may also be configured to other electrical components.

The voltage regulator 27 is connected by electrical wiring 24 to a battery charger 25, may be an integrated circuit chip that controls the charge current and voltage required to charge the battery 20. The battery charger 25 may be configured with an internal switch that controls the charge current and voltage and determines when to turn the charge function on and off. The battery charger 25 operatively connects to the rechargeable battery 20.

Energy flows through the invention as follows:

Rechargeable battery 20 sends electric power through Electronic Speed controllers to electric motors 12. The powered electric motors 12 spin the attached propellers/fans 14 which provides lift and propulsion to the vehicle. Prop wash from the propellers/fans 14, spun by the electric motors 12 turns propellers/fans 14 connected to electric generators 18, thereby generating electricity. Additionally, rotation of electric motors 18 may also spin the shafts of connected micro generators 32, generating electricity.

In addition to the foregoing, in some embodiments, an auxiliary electric generator 18′ and auxiliary prop assemblies 14″ may be attached directly to the vehicle hub 10 to harness an air flow 16 moving across the UAV, particularly during translational flight modes, to spin these additional electric generators 18′, thereby generating electricity. The sum of the generated power is channeled through various aforementioned electric components 20 to condition the power for recharging the battery 20 and/or powering equipment.

The system may be configured by connecting the rechargeable battery 20 to the Electronic Speed Controllers (ESC's) 50 using electrical wiring 24. Connect the propellers/fans 14 either directly to the shafts 13 of the electric motors 12 or to gearboxes that are attached to the shafts 13 of the electric motors 12. The electric generators 18 are operatively attached to the propellers 14′ to the multi-rotor UAV's frame 10 in a manner such that the generators would lie within the prop wash (airflow) generated by the electric motors 12 and associated propellers 14 when the electric motors 12 are in operation, and oriented so that the rotation of the propellers 14 attached to the electric motors 12 parallel to the rotation of the propellers 14′ attached to the electric generators 18.

The shafts of micro generators 32 may be attached either directly to the shafts 13 of the electric motors or to gearboxes attached to shafts 13 of electric motors 12, such that for each rotation of the shaft 13 of the electric motor 12 results in one or more rotations of the associated micro generator 32. Micro generators 32 can also be attached in similar fashion to the larger electric generators 18.

Additional generators/propellers/fans assemblies are attached to frame of multi-rotor in a manner that will allow them to harness ambient airflow around the vehicle that turns the propellers/fans attached to these generators' shafts (or attached to gearboxes attached to generator shafts).

Electrical wiring 24 connects each electric generator 18 and micro generator 32 to the AC-to-DC rectifier, which is connected by electrical wiring 24 to the Step-up (boost) converter, which is connected by electrical wiring 24 to the capacitor, which is connected by electrical wiring to the voltage regulator, which is connected by electrical wiring to the battery 20 charger, which is connected by electrical wiring to the rechargeable battery 20.

Gearboxes are not necessary to the functionality of the design. Micro generators 32 are not necessary to the functionality of the design. Additional electric generators driven by the airflow around the vehicle as it moves through the air are not necessary, however some additional power generation method must be introduced to the system (i.e., solar cells) in order to supplement power generated by electric generators (in the prop wash of the propulsion system) and create a sum of power necessary to recharge the battery 20. Implementations of this invention using only electric generators in prop-wash of propulsion system will still be able to generate power that can be used to power onboard electric equipment and, thereby, extend the charge duration of the rechargeable battery 20 while in operation.

Any combination of generator/micro generators 32 can be utilized based on the vehicle's size, mission profile, weight, etc., in order to generate electricity that can be utilized to power onboard electrical equipment, thereby prolonging the charge of the battery 20, or recharging the battery 20.

To use this invention, it could be installed on an existing multi-rotor UAV or a fixed-wing UAV. This would involve placing electric generator 18 and propellers 14′ in the prop wash of the existing propulsion system, or optionally placing micro generators 32 on the motors of the existing propulsion system. The generators 18′ and propeller 14″ on the airframe 10 of the existing vehicle to capture airflow 16 as the vehicle moves through the air.

It should be understood, of course, that the foregoing relates to exemplary embodiments of the invention and that modifications may be made without departing from the spirit and scope of the invention as set forth in the following claims.

What is claimed is:

1. An in-flight charging system for an unmanned aerial vehicle (UAV), comprising:
a hub portion,
a motor attached to the hub portion via a support arm,
a rotor rotationally driven by the motor to produce a thrust airflow; and
a prop oriented for rotational movement in the thrust airflow and operatively coupled to a generator via a generator shaft, the generator producing a first electrical charge responsive to the rotational movement of the prop with the thrust airflow.

2. The in-flight charging system of claim 1, further comprising:
a power conditioning circuit, coupled to the generator, and configured to produce a regulated direct current output from the first electrical charge.

3. The in-flight charging system of claim 2, further comprising:
a battery, operatively coupled to the power conditioning circuit, wherein an output of the power conditioning circuit charges the battery.

4. The in-flight charging system of claim 1, wherein the prop is coaxially aligned with the rotor.

5. The in-flight charging system of claim 2, wherein the power conditioning circuit further comprises:
an AC to DC rectifier coupled to the generator;
a voltage regulator coupled to the AC to DC rectifier;
a boost converter; and
a battery charger integrated circuit.

6. The in-flight charging system of claim 5, further comprising:
a storage capacitor operatively coupled to the voltage regulator.

7. The in-flight charging system of claim 2, further comprising:
a micro generator operatively coupled to a motor shaft, the micro generator adapted to produce a second electrical charge with rotation of the motor shaft.

8. The in-flight charging system of claim 7, wherein the power conditioner receives the second electrical charge.

9. The in-flight charging system of claim 1, further comprising:
an auxiliary generator operatively coupled to the hub portion, the auxiliary generator driven by an auxiliary prop oriented to receive an airflow across the hub.

10. The in-flight charging system of claim 1, wherein the motor comprises a ducted fan.

11. The in-flight charging system of claim 10, further comprising:
a flight control surface oriented subjacent to an outlet of the ducted fan.
